(19) United States
(12) Patent Application Publication
(10) Pub. No.: US 2017/0178072 A1
(43) Pub. Date: Jun. 22, 2017

(54) System, Apparatus And Method For Transferring Ownership Of A Smart Delivery Package

(71) Applicant: Intel Corporation, Santa Clara, CA (US)

(72) Inventors: Rajesh Poornachandran, Portland, OR (US); Ned M. Smith, Beaverton, OR (US)

(21) Appl. No.: 14/977,753

(22) Filed: Dec. 22, 2015

(51) Int. Cl. G06Q 10/08; G06Q 20/38; G06Q 20/32

(52) U.S. Cl. CPC G06Q 10/0833; G06Q 20/3224; G06Q 20/3276; G06Q 20/3827; G06Q 20/3829

(57) ABSTRACT

In one embodiment, an apparatus comprises: a hardware processor, a storage to store a digital title comprising a first ownership record having a public key of a current owner of the apparatus, the public key to be endorsed by a prior owner of the apparatus, and a wireless circuit to transmit and receive messages. The hardware processor may be adapted to generate a hash of a prior ownership record, and the wireless circuit is to cause the hash to be provided to a remote server that is to maintain a block chain regarding ownership of the apparatus. Other embodiments are described and claimed.

### BACKGROUND

In current package delivery systems, package security during routing depends on integrity of a package registration and inventory process of a given shipping service, where package location can be determined based on identifying presence of the package at each intermediate point during its trip from source to destination. As package delivery becomes automated, performed by drones and other automation, routing infrastructure may not be centrally owned and operated. Consequently, current assurances enjoyed regarding reliable package delivery may not be viable going forward. Instead, it is possible that independently-owned delivery devices may vie for packages to deliver, where these devices may not be trusted to not forge delivery orders and receipts.

### BRIEF DESCRIPTION OF THE DRAWINGS

FIG. 1 is a block diagram of a high level system architecture in accordance with an embodiment of the present invention.

FIG. 2 is a block diagram of a system architecture in accordance with an embodiment of the present invention.

FIG. 3 is a flow diagram of an operational flow for an example package delivery scenario in accordance with an embodiment of the present invention.

FIG. 4 is a flow diagram of the fine granular operational flow for a given ownership transfer stage in accordance with an embodiment.

FIG. 5 is a flow diagram of a high level method for transferring ownership of a smart package in accordance with an embodiment of the present invention.

FIG. 6 is a flow diagram of a high level method for smart package ownership transfer in accordance with another embodiment.

FIG. 7 is a communication diagram of a sequence of communications and operations between devices for an ownership transfer in accordance with an embodiment.

FIG. 8 is a flow diagram of a geo-fencing method in accordance with an embodiment of the present invention.

FIG. 9 is a block diagram of an example system with which embodiments can be used.

FIG. 10 is a block diagram of a system in accordance with another embodiment of the present invention.

FIG. 11 is a block diagram of a wearable module in accordance with another embodiment.

### DETAILED DESCRIPTION

In various embodiments, digital ownership information in the form of a digital title can be applied to a so-called smart package such as Internet of Things (IoT) device, to enable a secure record of package delivery from a source to a destination. In an embodiment, a smart package may include one or more semiconductor devices such as small integrated circuits (ICs) that incorporate a system on chip (SoC) or other processor to provide a trusted execution environment (TEE) to enable this secure digital record to be maintained regarding ownership transfers during transit from source to destination. As an example, a smart package can be used to deliver articles such as goods and/or sensitive/confidential information. End-to-end delivery from source to destination may include an efficient and secure mechanism to track the delivery via dynamic ownership provisioning. As such, at each stage of a delivery pipeline correct ownership can be asserted, preventing an adversary take over.

Embodiments may be used to transfer smart package ownership from an original manufacturer to the device's first owner and for subsequent transfers. Embodiments provide a cryptographically protected object known as a digital title. The title is a data structure that establishes a device identity and then cryptographically binds the device owners to the title according to the number of times the device ownership state changes. A device owner transfer protocol ensures the title is authenticated, updated and transferred such that the title reflects the owner transfer semantics and that unintended semantics are also controlled.

A smart package or delivery container itself thus includes the capability to determine what delivery resource (e.g., drone) takes possession of it, and record any intermediate control transfers to another delivery resource (e.g., a second drone) during transit from source to destination. In an embodiment, the container records any hand-off or other transfer using a block chain that can be independently verified. As such, a race to ownership challenge can be averted by integrating the notion of a digital title into the smart container.

In an embodiment, a non-network-based ownership management model may be implemented. In some cases, this model may be implemented at least in part using a (non)-digital electronic network, and which may leverage various communication techniques, including but not limited to one or more of near field communication, radio frequency, ultrasonic, haptic or visual communication means. Different techniques may be used to communicate between different entities in this model. In an embodiment, wireless technologies may be used to enable communication between at least some entities. In one particular embodiment, a smart container as described herein may implement Intel® Wireless Credential Exchange (WCE) technology that leverages radio frequency (RF)-based communications to perform ownership provisioning. In an embodiment, RFID is used for this communication. Using Intel® WCE over RFID, provisioning of an ownership title is possible. Intel® WCE or other wireless communication technology also provides for scalability and the opportunity for re-programmability on an as needed basis, and may also enable other policies, like geo-fencing of the package. In such case, if the package is determined to be in a non-allowed geo-fence location, it may be locked and/or send appropriate out-of-band alerts.

To initialize a smart container or other delivery mechanism to provide a digital title as described herein, a manufacturer of the package (and/or a manufacturer of one or more semiconductor devices that provide the processing capability of the package) may install a root authorization key in each device at the factory. This root authorization key may thus indicate that the manufacturer is the initial owner of the device. As such, a digital title for the device may include information identifying this original ownership.

Thereafter, as the device moves through additional stages of a manufacturing/delivery pipeline, an ownership transfer protocol may be performed to replace the original (manufacturer's) root key, which is a different key than the root authorization key, with a new owner's key at every stage of the pipeline. This manufacturer's root key is also referred to herein as a root record, which distinguishes this record as the first instance of the title, as generated by a manufacturer of the device, and containing a public key. In turn, a new owner supplies an owner-record containing a public key. In one embodiment, a digital title may take the form shown in Table 1.

TABLE 1

title:: root-record | title owner-record
root-record:: device-record owner-record
device-record:: device-id device-description maker-id
maker-public-key maker-signature
device-id:: byte-string
device-description:: byte-string
maker-id:: byte-string
maker-public-key:: public-key
maker-signature:: signature
owner-record:: buyer-public-key hash xfer-time seller-endorsement
buyer-public-key:: public-key
hash:: bit-string
xfer-time:: timestamp
seller-endorsement:: signature

As will be described further below, this digital title initially includes a root-record and a device-record, where the root-record is an owner-record that names the manufacturer. When ownership is transferred, a new owner-record is appended to the existing title (having this root-record and device-record initially).

As such, a digital title stored in the device may be dynamically updated throughout the course of manufacturing/delivery operations such that an accurate record reflects a current device owner, as well as a chain of ownership title to this current owner. Understand further that this ownership record chain may be validated by way of a block chain of all ownership transfer records, which may be implemented by a third party, such as a cloud service having one or more cloud servers that provide for block chain recording activities.

In one embodiment, an Intel® SigmaCE (sign and MAC) protocol may be used for transferring the title that accommodates the title data structure. Privacy is also a concern for titled devices as unique identifiers such as a device ID may be used to track and correlate transactions involving the device across multiple owners. Embodiments may address privacy concerns in part by basing the identity on a secure identifier such as an Intel® enhanced privacy identifier (EPID) or another privacy preserving cryptographic technique such as a direct anonymous attestation (DAA) identifier.

As will be described herein, embodiments enable a computation to be performed on the ownership record chain (e.g., a hash computation) at various configurable states to realize a finger print that can be verified against allowed and not allowed configurations.

As an example illustration, consider the following sequence of ownership provisioning and transfer for a package:
1) shipper schedules delivery to it of empty smart container, e.g., using an Internet-based system (original ownership: manufacturer);
2) drone delivers empty smart container and smart container transfers ownership to the shipper using ownership title (new ownership: shipper);
3) ownership title updates a block chain to record the owner transfer event (which may occur in a cloud server);
4) shipper places article to be delivered in container and seals container;
5) shipper schedules container for delivery to customer, e.g., using Internet-based system;
6) drone arrives; smart container ownership title is transferred to drone (new ownership: drone);
7) block chain is updated (in the cloud server);
8) drone delivers smart container to the customer;
9) customer takes ownership of the smart container using ownership title (new ownership: customer);
10) block chain is updated (in the cloud server);
11) customer schedules empty smart container for pickup using Internet-based system;
12) drone arrives to take away smart container;
13) container ownership title transfers container ownership to the drone (new ownership: drone); and
14) block chain is updated (in the cloud server).

Using an embodiment, security can be provided throughout a package delivery process, without relying on factory or network provisioning. As such, security may be enhanced, as network-based provisioning is vulnerable and a factory mechanism does not allow flexibility/reusability (especially for IoTs used for packaging).

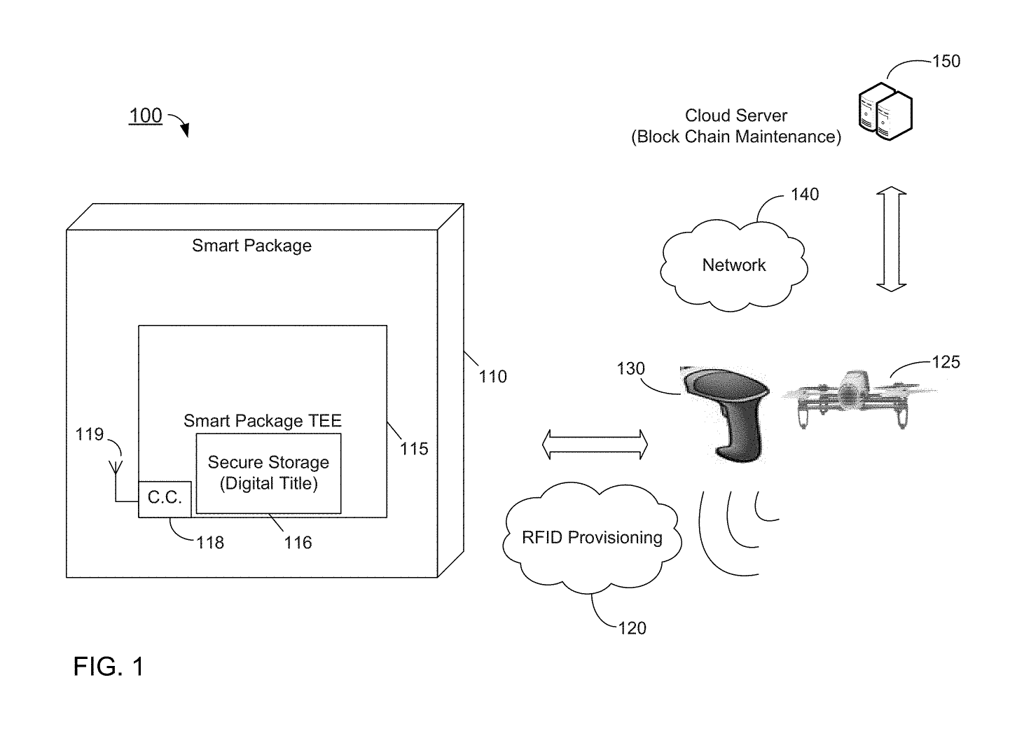

Referring now to FIG. 1, shown is a block diagram of a high level system architecture in accordance with an embodiment of the present invention. As shown in FIG. 1, environment 100 enables interaction between disparate entities that may be in communication using a wide variety of different communication techniques. As seen, a smart package 110 may be any type of container used to deliver goods/information from a source to a destination. In one embodiment, smart package 110 may be a reusable container in which a secure item, such as a technology device (e.g., a smartphone, personal digital assistant, tablet computer or other relatively portable computing device) may be housed for delivery from a given source to a given destination (such as from an OEM or reseller to a business or consumer). Such delivery may occur via one or more (e.g., non-networked) shipping services that provide for delivery via one or more intermediate stops and/or transfer of delivery agents.

As illustrated, smart package 110 includes a smart package trusted execution environment (TEE) 115. In various embodiments, smart package TEE 115 may be implemented by way of one or more semiconductor devices such as ICs securely and permanently configured within smart package 110. As examples, smart package TEE 115 may be implemented as a single IC including one or more components that provide processing capabilities by way of one or more processing cores and/or other processing elements, such as a general-purpose processing core, and/or a separate secure processing element that may implement a TEE. In addition, a secure storage 116 may be provided, such as in the form of a non-volatile memory, e.g., implemented within a single IC with the processing circuitry or as a separate memory device. In any event, this circuitry may be permanently adapted within smart package 110, such as by being integrated into a tamper-proof portion of the package. In an embodiment, a TEE may be provided as a hardware isolation environment that leverages one or more of Intel® Software Guard Extensions (SGX), Intel® MemCore, Intel® Converged Security Engine (CSE), Intel® virtualization technology (VT-X), Intel® IOT-OS with Smack, ARM TrustZone among other secure environments, to provide a secure and isolated environment separate from a non-secure, e.g., operating system or other system software.

Secure storage 116 may provide a tamper-resistant storage environment to store ownership title information such as a digital title as described herein. To enable communication of information of this digital title, as well as to perform ownership transfers as described herein, a communication circuitry 118 may be provided within smart package TEE 115. As illustrated, a wireless antenna 119 may enable such RF communications. In an embodiment, communication circuitry 118 may be implemented as a wireless interface to provide wireless communication, e.g., via a short-range wireless protocol, such as a Bluetooth protocol, a RFID protocol, an IEEE 802.11 protocol, or any other such protocol. In other embodiments, communication circuitry 118 may also provide for a wide area wireless network communications, such as via a given 3G/4G and/or LTE communication protocol. In one particular embodiment, communication circuitry 118 may implement Intel® WCE, which is a RF technology with an I²C interface to securely and wirelessly exchange device information, including active (device on) and passive (device off) communication. Communication circuitry 118 may perform a secure challenge/response protocol to an external entity as described herein.

As further illustrated in FIG. 1, environment 100 may provide for ownership-based communications and transfers by way of a provisioning channel 120. In an embodiment, channel 120 may be implemented using RFID technology to enable an ownership transfer by way of one or more provisioning/delivery devices. Such devices include a provisioning device 130, which in an embodiment may be implemented as a manual RFID programmer used within one or more manufacturing and/or shipping entities to perform ownership provisioning. As further shown, a delivery resource 135 such as a delivery drone may further provide for RF communication capabilities via channel 120 to enable appropriate updates to ownership information.

Still further, to enable tracking of ownership throughout a delivery process, communications may occur via a network 140 (e.g., via an Internet network) to a cloud server 150. In various embodiments, cloud server 150 may provide for block chain ownership tracking by way of updates received from various entities during delivery of smart package 110 from source to destination. Understand while shown at this high level in the embodiment of FIG. 1, many variations and alternatives are possible.

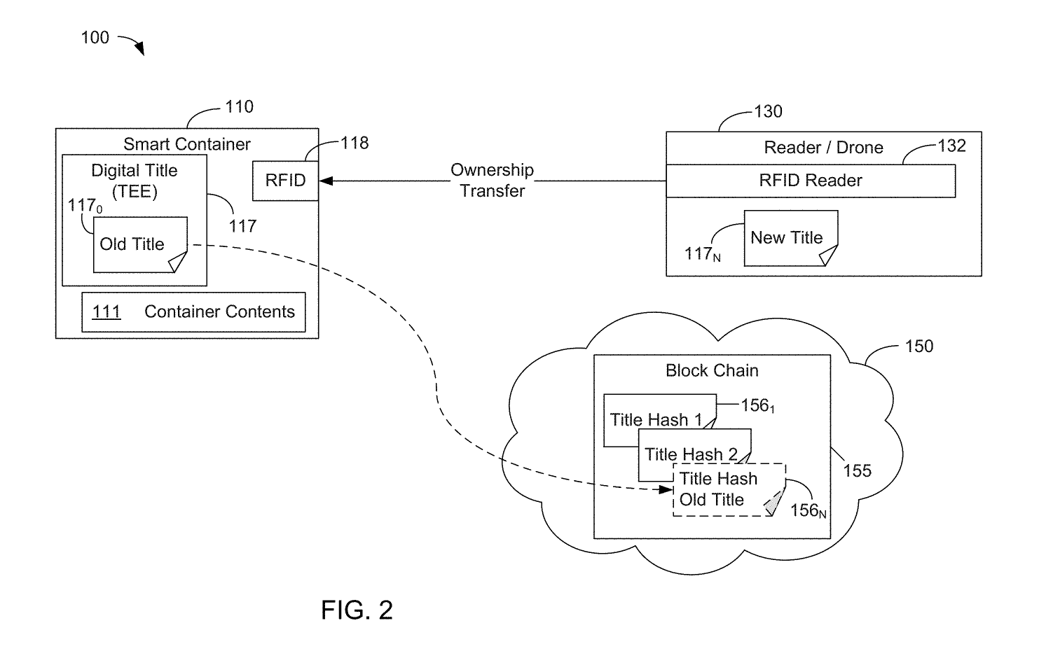

Referring now to FIG. 2, shown are further details of a system architecture in accordance with an embodiment of the present invention. In the illustration shown in FIG. 2, smart container 110 is in communication with a second device 130, which may be a given communication device associated with an entity that is to take ownership of smart container 110. As examples, device 130 may be an RF reader of a manufacturer of a smart container, an RF reader associated with a shipper that is shipping smart container 110, and/or a drone or other delivery device that is performing at least a portion of a delivery from source to destination.

In any case, an ownership transfer process is implemented using communication circuitry 118 of smart container 110 and communication circuitry 132 of device 130. In an embodiment, such communication circuitry may be configured to perform RFID-based communications to update a digital title 117 stored in a secure storage of smart container 110, which at the start of a protocol, an old title record 117ₒ. As further illustrated, smart container 110 includes container contents 111, which may be an article to be delivered, such as a technology device, secure information, legal documents, household items or so forth.

To enable an ownership transfer to occur, a new ownership record 117ₙ is generated in device 130 and provided for storage in a secure storage of smart container 110. In addition, old title 117ₒ, corresponding to a prior ownership record of secure container 110, may be used to generate a title hash, which may be provided to a cloud server 150 for storage in a block chain 155, which includes a plurality of title hashes 156₁-156ₙ, each of which is a hash value of a prior ownership title of smart container 110.

In some embodiments, each subsequent owner may append an owner-record to the title, resulting in a new title that is a concatenation of all previous owners. This could be a privacy problem since the full history of ownership is contained in the title. Rather than maintain a full history in the title, an alternative is to hash the previous title and contribute it to the block chain. The subsequent concatenation hash is generated by hashing the previous block chain value with the new owner-record hash. This produces a new hash that may be contributed to the block chain.

Anyone who knows or can guess the sequence of title ownership exchanges can use the block chain to prove they know the sequence. The title therefore may be encrypted or otherwise hidden from view to protect privacy, and only decrypted/revealed within a TEE during owner transfer operations. In turn, the TEE would only reveal the title hash to the block chain. A third party TEE could (e.g., under order of a court) receive a hash from the block chain and evaluate whether the title contains the block chain hash or not. Such operation does not cause the title to be revealed in the clear. This would allow dispute resolution over whether a given drone A or drone B delivered a given package P. The court-ordered TEE need not disclose any other history involving other drones or packages.

By using block chain 155, a verifiable history of previous owners may be maintained. Each time ownership of smart container 110 is established; the old ownership title is hashed and signed by an embedded key of smart container 110. Signed hash 156ₙ is linked to previous ownership titles if existing (e.g., title hashes 156₁-156₂). The hash value protects privacy by requiring the verifier to have a priori access to the title in order to generate the hash. Cloud server 150 cannot create fake block chain entries because it does not possess the smart container's key.

When a new owner is established, the new ownership title may be provisioned via interface 118. In an embodiment, a sign and MAC protocol variant, such as an Intel® SigmaCE protocol, may be used to negotiate the installation of new title 117ₙ and receipt of the signed old title hash 156ₙ for contribution to block chain 155. In an embodiment, smart container 110 may refuse to install a new title until cloud server 150 acknowledges receipt of an old title hash.

Referring now to Table 2, shown is an ownership title structure in accordance with an embodiment.

TABLE 2

| | |
|---|---|
| Title | root-record \| title owner-record; |
| Root-record | device-record \| owner-record; |

Struct device-record {

GUID Device-id;
String Device-description;
GUID Manufacture-id;
Key Manufacturer-public-key;
Signature Manufacturer-signature;

};
GEO-CONSTRAINT Location;
TIME_CONSTRAINT XferTimeLock;
Struct Owner-record {

Key Buyer-Public-Key;
HASH XferTimeHash;

};
SHA512_HASH ElementFingerprint;
Signature seller-endorsement;
} Ownership Title;
Typedef stuct {
GUID PlatformID;
UINT64 NumberOfPlatformElements;
Ownership_Title Elements[1];
} Ownership_Chain;

In the above structure of Table 2, device-id is unique to a given smart package relative to the manufacturer, which is identified by manufacture-id and manufacturer-public-key. The design assumes the smart package can recognize a valid manufacturer-public-key, e.g., its hash is stored in a non-volatile storage (e.g., ROM). The device-description is the manufacturer's description of the smart package. The buyer public-key of the first ownership-record is the manufacturer-public-key from the device description and the signature is verified using that key. The ownership-record chain is similar to a Bitcoin block-chain. Ownership transfer can be effected by the seller verifying a new ownership record, upon verification of the same, deleting the old ownership record and replacing it with the new ownership record, endorsing the public key of the buyer with the signature of the seller.

Note that with regard to the title structure shown above, certain fields may be static, while other fields may dynamically change during an ownership transfer. In one embodiment, device-id, device-description, manufacture-id, manufacture-public-key, and manufacturer-signature, may all be static fields. In turn owner-record, buyer-public-key, hash, xfer-time and seller-endorsement may dynamically be updated as a result of an ownership transfer. However, in some cases a device-id may change on ownership transfer to protect privacy. Note that geo-location and time constraints are examples of constraints that may be placed on ownership transfers. Platform elements could include (in addition to device ID) make/model/version/serial# of the device. It may further include attributes that are sensed via sensors attached to the device (e.g., accelerometer, barometric pressure, ultrasonic, infrared etc.). The sensed context may be included in the title as further evidence related to the physical environment that a drone/package experienced at the time in which an ownership transfer occurred. Context data may further be used to prescribe a physical world context that is to exist before a next owner transfer may occur, for example, the drone/package is to be in a particular geo-location.

In an embodiment a representative set of protocol messages may be used to transfer ownership in accordance with an embodiment of the present invention. At a high level, after a secure key exchange, a message may be sent by a buyer to establish the buyer is interested in obtaining ownership, and a seller includes the hash of the old title in a Diffie-Hellman (DH) exchange to express an interest in transferring ownership. In a subsequent message, the buyer verifies the current owner indeed owns the device to which the buyer intends to become the new owner. In a following message, the buyer completes the title transfer by signing and (optionally) encrypting the new title before delivering it to the device. The device verifies that the new title (constructed by the buyer) matches the terms established by the seller as represented in the new-owner-record. The appropriate fields are compared for accuracy, and then a new title along with a new owner-record appends to the previous title (containing a previous owner-record). Alternatively, the new owner-record is appended to an encrypted title by a TEE that ensures the title information is only exposed to a TEE.

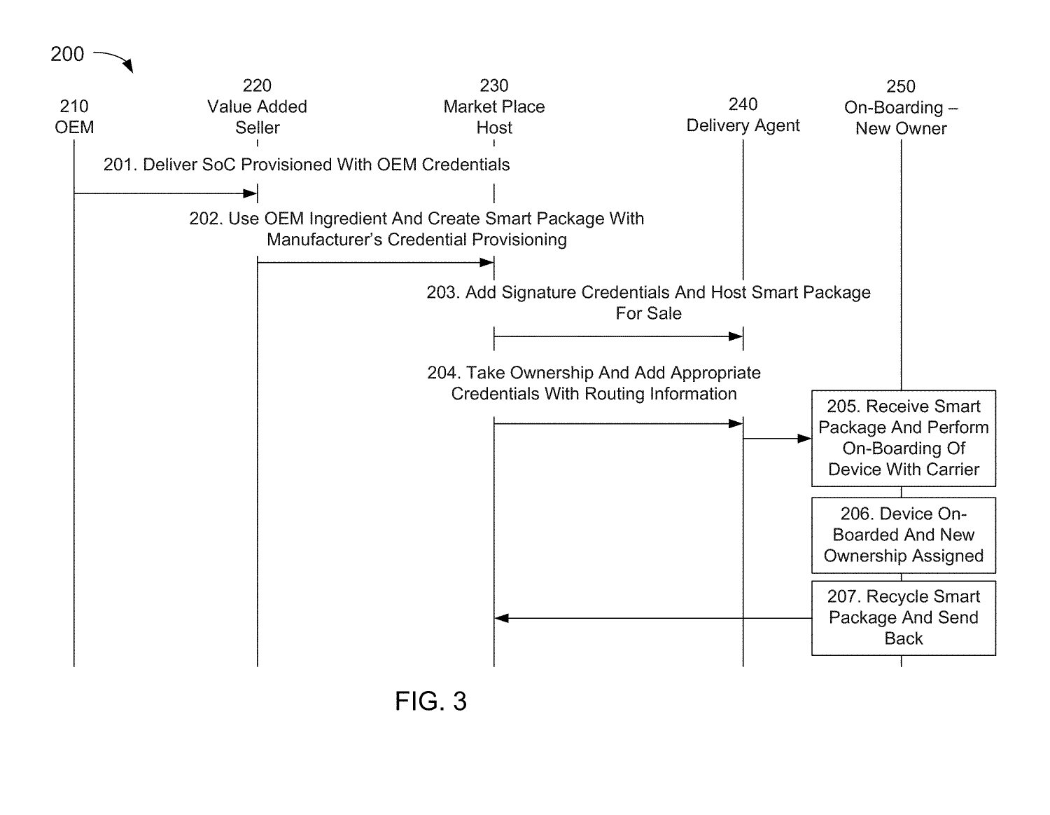

FIG. 3 shows an operational flow for an example scenario package delivery. More specifically, FIG. 3 shows ownership transfers extending from a manufacturer OEM 210 all the way to an end user 250 (such as a subscriber to a wireless carrier). Assume for purposes of discussion that this OEM (e.g., Intel Corporation) is a manufacturer of an SoC or one or more other integrated circuits that form a trusted execution environment for a smart container that in turn may be manufactured by another entity in the ownership chain. Thus as shown in FIG. 3, a value added reseller 220 may be a manufacturer of the smart package itself, e.g., 3M, that builds the smart package including one or more ICs, e.g., as received from OEM 210. In turn, the smart container built by value added reseller 220 may be provided to a marketplace host 230, such as an online retailer, e.g., Amazon. In turn, when a sale or other interaction occurs between marketplace host 230 and a new owner 250, such as an end user, a delivery may be arranged. As shown, a delivery agent 240 may be yet a different entity, such as a shipping service, e.g., UPS.

Also assume for purposes of discussion that the smart package delivery to the end user is of a computing device, such as a new smartphone to be delivered, e.g., by a drone or other non-network-based shipping channel to the end user. Note that in the operational flow shown in FIG. 3, there is no ownership transfer to the carrier itself, and instead a smart package including the smartphone or other device may be delivered directly from marketplace host 230 to end user 250 via delivery agent 240 (and/or one or more other delivery agents).

The embodiment shown in FIG. 3 involves an ownership protocol being used with secure remote attestation and provisioning at every stage. Each ownership stage may be verified using a block chain maintained at a back end cloud server. Understand that in the embodiment shown in FIG. 3, each stage entity may be an owner of package delivery drones and/or other delivery devices as described herein. Note further that while shown with these particular entities for discussion purposes, in actual implementations more or fewer entities may be involved in an operational flow from manufacturer to end user (e.g., including multiple independent delivery agents, each providing one or more delivery drones or other such devices).

As illustrated in FIG. 3, at step 201, the OEM may deliver one or more SoC's with communication capability and provisioned with OEM credentials. Although the scope of the present invention is not limited in this regard, in one embodiment such OEM credentials may include an embedded manufacturer key. In some cases, this information may further include context established by sensors. In addition, attributes about the OEM (signer) may be included in the device-record including quality metrics such as ISO9000, common criteria, FIPS or other quality metrics. Normally, these may be included in a certificate issued for the public key, but need not be included. Then at step 202, value added seller 220 may use such OEM ingredients to create a smart package having the manufacturer's credential provisioning. As such, an owner transfer mechanism may be applied early in the manufacturing process. In fact, it could be used to protect the supply chain that produces the device (e.g., smart package/drone). With each owner transfer event, the device record attribute list may be augmented to include, for example, a maker2-id, maker2-device description and even a maker2-deviceID. Most likely, though the maker2 will supply make/model/version information and possibly remove previous maker make/model/version if the supply chain process is such that this information would conflict. The hash in the owner-record will reflect any changes made to the device-record from the previous owner. The seller-endorsement authorizes these changes by agreeing to supply the seller-endorsement.

Still referring to FIG. 3, at step 203 marketplace host 230 adds signature credentials to the smart package and hosts the package for sale. Note here that this posting of the item for sale may be for the secure contents, e.g., smartphone, to be delivered by way of the secure container itself. At step 204, delivery agent 240 may take ownership of the smart package and add appropriate credential information into the digital title. In addition, routing information also may be stored into the secure storage, which may be used in performing geo-fencing operations as described herein.

After a purchase is made by end user 250 (e.g., an online purchase via a website of marketplace host 230), delivery agent 240 may at step 205 deliver the package to the end user and update the digital title accordingly. Also at step 205, the user may perform an on-boarding process with a carrier with which it arranges service. Then at step 206 the device may be on-boarded into the carrier's network and new ownership of the device established. At this point, the transaction is completed. At step 207, the package may be recycled and sent back (e.g., via delivery agent 240 or another entity) to marketplace host 230 for re-use in another delivery. Also understand that while not shown at each ownership transfer described above, communications may occur with a back end cloud server to update a block chain associated with this smart package accordingly. Understand while shown at this high level in the embodiment of FIG. 3, many variations and alternatives are possible.

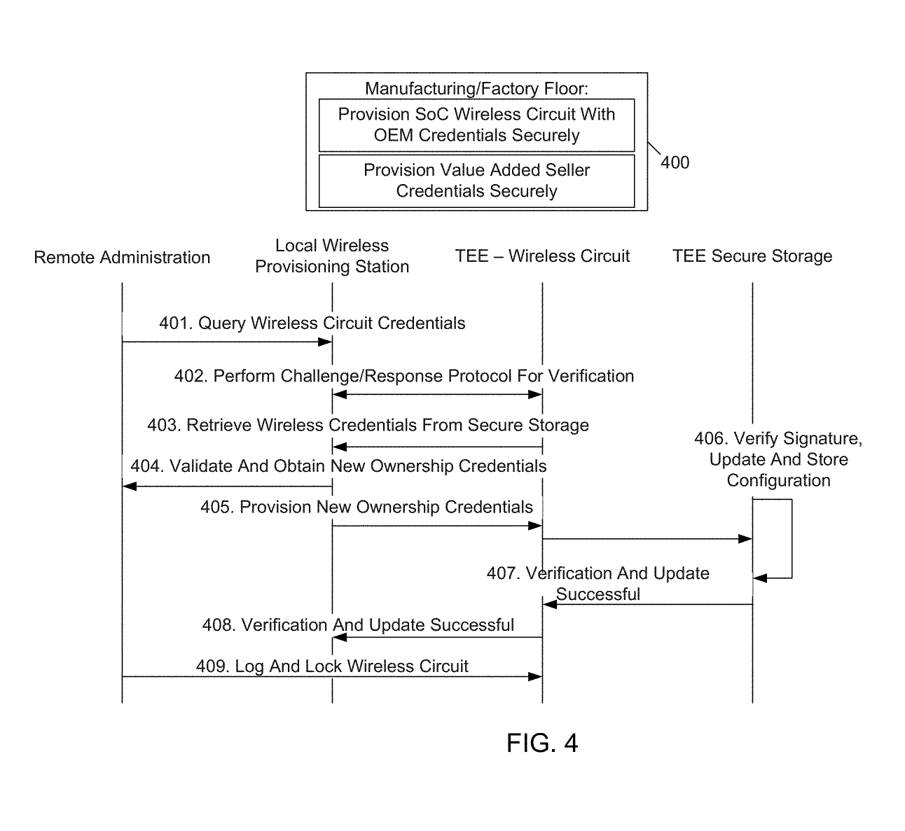

FIG. 4 shows the fine granular operational flow for a given ownership transfer stage in accordance with an embodiment. This involves initial port configuration provisioning on a communication circuit of the device, and manufacturer credential processing, either by OEM or value added seller (block 400). After such processing, at items 401-402, remote attestation of credentials stored in the platform communication circuit and TEE secure storage via the RF programmer may occur via a given challenge/response protocol. At items 403-404, verification of the ownership chain with geo-fenced data may occur. At item 405, an ownership transfer is provisioned with the geo-fenced data. Then at item 406, a new provisioning package (e.g., ownership record) is verified by the TEE prior to secure storage update. At items 407-409, acknowledgement of new ownership occurs and the ownership chain/provisioned data in TEE secure storage is locked.

Embodiments thus provide digital title ownership provisioning and tracking using wireless-enabled devices with cloud supported block chain tracking. Embodiments may also use network independent RFID as a transport means for updating ownership title.

The smart container thus receives the new title and verifies the container buyer (e.g., drone) is authorized to take ownership. Prior to replacing the old title with the new title, the smart package signs the old-title hash and delivers it to the new owner who forwards it to the cloud block chain. Upon receipt of the acknowledgement, the old title is replaced with the new title.

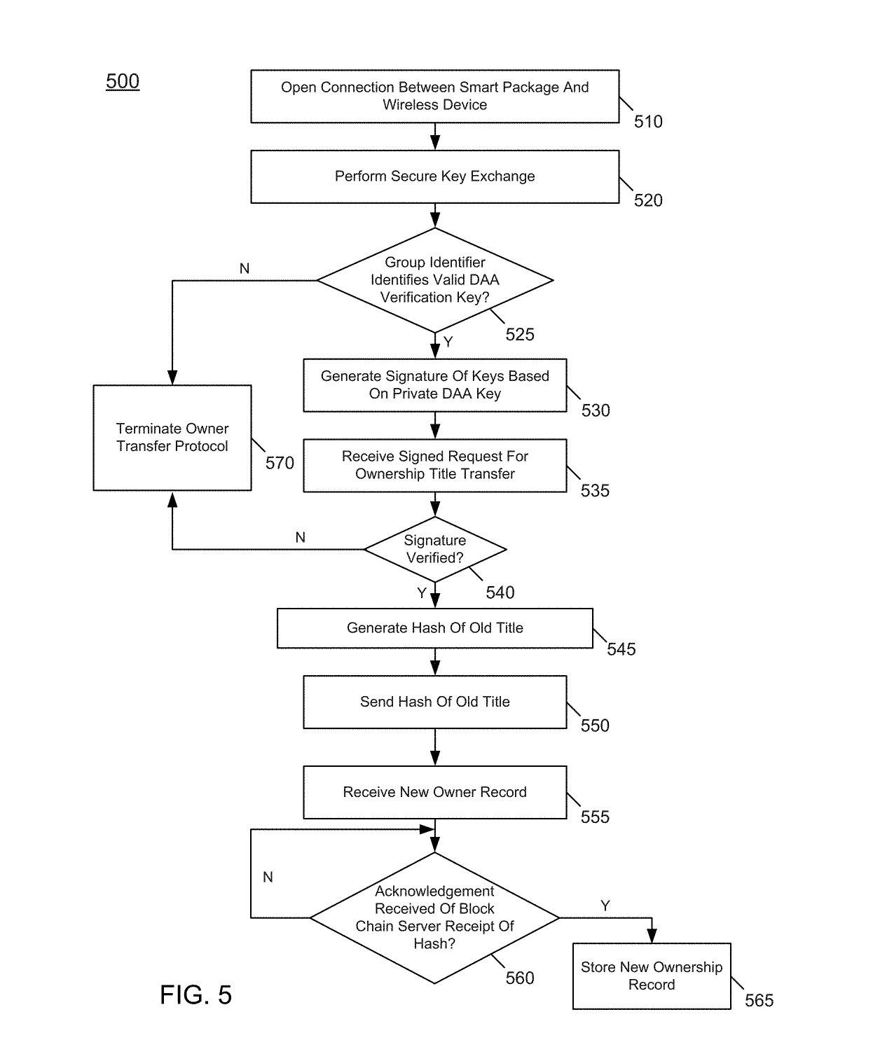

Referring now to FIG. 5, shown is a flow diagram of a high level method 500 for transferring ownership of a smart package (referred to in this example as a new device) to a new owner, namely an entity in a delivery chain from source to destination, from the point of view of the smart package. As seen in FIG. 5, method 500 begins by opening a connection between the smart package and the wireless device (block 510). This connection may be established responsive to a registration of the smart package at a delivery hub.

Thereafter at block 520 a secure key exchange is performed. Details of this secure key exchange are described below. Suffice to describe in one embodiment, this secure key exchange may be incorporated into a given secure communication session, such as a Datagram Transport Layer Security (DTLS) session. In the embodiment described herein, this key exchange may be based on a Diffie-Hellman (DH) key agreement protocol. At diamond 525, it is determined next whether a group identifier (received from the wireless device in the smart package) identifies a valid direct anonymous attestation (DAA) verification key of a DAA group. An Intel® Enhanced Privacy ID (EPID) and a Trusted Platform Module elliptic curve cryptography-based DAA (TPM ECDAA) are examples of DAA keys that implement a DAA algorithm. If diamond 525 is in the affirmative, control passes to block 530 where the smart package may generate a signature of a set of keys based on its private DAA key. In an embodiment, the keys on which this signature is generated may include the public DH keys of the devices.

Next at block 535, the smart package receives a signed request for ownership title transfer. Using this request, the smart package may determine whether the signature is verified (diamond 540). If so, control passes to block 545, where the smart package may perform various operations, including generating a signed hash of the existing ownership title record of the smart package (referred to in this embodiment as an “old title”) (block 545). Then at block 550, the smart package may send the generated hash to the wireless device. As will be described further below, responsive to receipt of this hash, the wireless device may verify it to confirm proper ownership chain. Assuming valid verification, the wireless device then sends a new owner record, which as shown in FIG. 5, the smart package receives at block 555.

Still with reference to FIG. 5, at diamond 560 it is determined whether the smart package receives acknowledgement of block chain server receipt of the hash (previously provided to the wireless device, which thus acts as the intermediary between the smart package and the block chain server). Responsive to successful acknowledgement, control passes to block 565 where the smart package may store the new ownership record in its secure storage. In an embodiment, the old ownership record may be deleted at this time as well. As further shown in FIG. 5, should verifications not be successfully performed, control passes to block 570 where an ownership transfer protocol may be terminated. Understand while shown at this high level in the embodiment of FIG. 5, variations and alternatives are of course possible. For example in other embodiments, additional information may be provided from the buyer device and incorporated into the title.

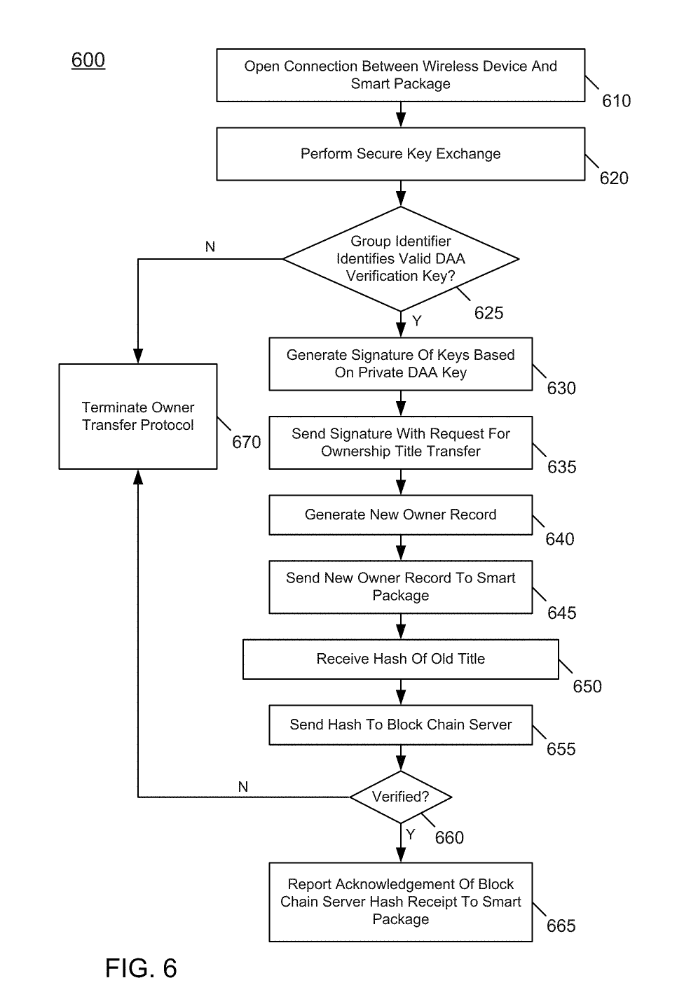

Referring now to FIG. 6, shown is a flow diagram of a high level method for smart package ownership transfer, this time from the point of view of a computing device, e.g., a wireless device such as an RFID reader, drone or other wireless (or wired) computing device. As above, a connection is opened between the devices and a secure key exchange is performed (blocks 610 and 620). Further as described above, the wireless device can determine whether a group identifier identifies a valid DAA verification key and if so, a signature of DH public keys may be made based on the private DAA key of the wireless device (diamond 625 and block 630). This signature may be sent with a request for ownership title transfer to thus transfer ownership in the smart package to the delivery chain entity. At block 640 the wireless device may generate (or receive from another computing device) a new owner record for updating an ownership title record. In some embodiments, the wireless device also may encrypt and sign this new owner record. At block 645, the new owner record is sent to the smart package. As will be described herein, the smart package may verify this new title and cause its title to be updated with this new owner record.

As further illustrated in FIG. 6, at block 650 a hash of the old title is received in the wireless device. As described above, the smart package generates this hash of the old title and provides it to the wireless device, to enable the wireless device to in turn send the hash to the block chain server (block 655). At diamond 660 it is determined whether this hash is verified such that the block chain server confirms correct ownership transfer according to the block chain that it maintains. If so, at block 665, the wireless device may report acknowledgment of the block chain server hash receipt to the smart package. As described above and responsive to this acknowledgment, the smart package may update its digital title accordingly with the new ownership record. Note that if the various verifications do not succeed, control passes to block 670 where the owner transfer protocol is terminated. Understand while shown at this high level in FIG. 6, many variations and alternatives are possible.

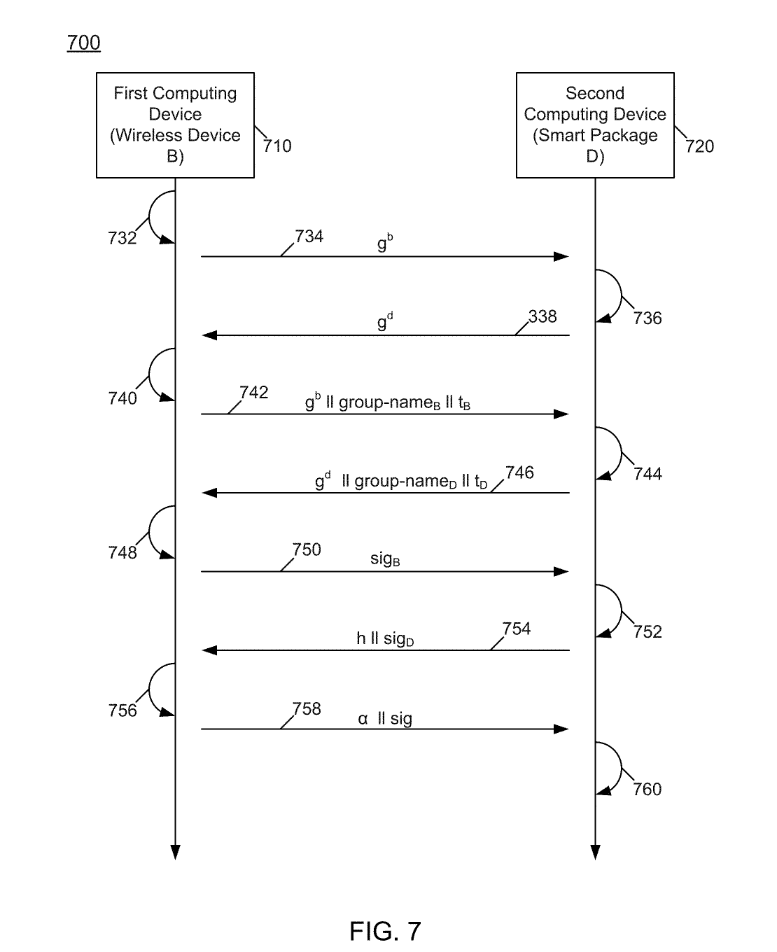

Referring now to FIG. 7, shown is a communication diagram of a sequence of communications and operations between devices for an ownership transfer and a smart package (also referred to as a second computing device or a seller device) to transfer ownership, in accordance with an embodiment. This ownership transfer may be performed in an environment 700, which may be a given network such as an IoT or other network.

Referring now to FIG. 7, a first computing device 710 (namely a computing device, B, such as a server computer, desktop computer, or more likely a wireless device such as a tablet computer, smartphone, delivery drone, or other portable device) establishes a secure communication channel with a second computing device 720 (namely a smart package D, currently owned by a first entity (S)), to which buyer B seeks ownership. Initially, device 710 may perform a sub-flow 732 to generate a private DH key, b, of first computing device 710. In an embodiment, this private key may be generated according to: b←ₛ{0,1}ⁿ. It is appreciated that DH keys and/or other calculations described herein may be performed under a selected prime modulus (via modulo arithmetic). Further in selecting the private DH key, b, computing device 710 may select a random integer or n-bit sequence (mod the selected prime).

Thus a message 734 is sent, which communicates a public DH key, g^{b}, for computing device 710 based on the private DH key. Note that the primitive root g is a generator for an abelian group under the selected prime modulus and is used by both computing devices 710 and 720 during the secure key exchange protocol. These devices may use any suitable technique to agree upon the particular primitive root and prime for the exchange.

At sub-flow 736, second computing device may verify that g^{b} is an element of the Diffie-Hellman group. Device 710, also at sub-flow 736 may generate a private DH key, d, of computing device 720, in accordance with: d←ₛ{0,1}ⁿ. Still further in sub-flow 736, computing device 710 generates a public DH key g^{d} based on the private key.

Second computing device 720 may thus send message 738 including this public DH key g^{d} to first device 710. Next, in sub-flow 740, device 710 may verify that g^{d} is an element of the Diffie-Hellman group. Also during sub-flow 740, device 710 may generate a shared public key, g^{db}, perform various pseudo-random function (PRF) calculations, and then generate a keyed hash, t_{B}, e.g., according to a suitable hash algorithm. More specifically in sub-flow 740, first device 710 may perform the following: g^{db}←(g^{d})^{b}; dk←prf(0,g^{db}); delete b and g^{db}; ak←prf(dk,1); and t_{B}←prf(ak,g^{b}∥group-name_{B}). In an embodiment, this group-name may include a hint to find a DAA verification key for a DAA group with which the device is associated. In an embodiment, t_{b} may be generated to provide a temporary pseudo-random function value, such as a temporary hash used to provide handshake context. Then first device 710 sends message 742, which includes the public DH key, DAA group identifier, and/or the keyed hash of computing device 710, as follows: g^{b}∥group-name_{B}∥t_{B}.

Still with reference to FIG. 7, at sub-flow 744, computing device 720 may verify g^{b} is as above, and verify that group-name_{B} identifies a known DAA verification key. Further, computing device 720 may generate g^{bd}←(g^{b})^{d}; dk←prf(0,g^{bd}); delete d and g^{bd}; ak←prf(dk,1); and verify t_{B}=prf(ak, g^{b}∥group-name_{B}). Still further during this sub-flow, second device 720 may generate a keyed hash according to: t_{D}←prf(ak, g^{d}∥group-name_{D}). Then second computing device 720 may send message 746 including g^{d}∥group-name_{D}∥t_{D}, to computing device 710.

In sub-flow 748, first computing device 710 may verify g^{d} is as above, verify group-name_{D} identifies a known DAA verification key, and verify t_{D}=prf(ak, g^{d}∥group-name_{D}). Assuming that this verification proceeds successfully, first device 710 may then generate a request for ownership via a title transfer in accordance with the following calculations to generate a signed request: v←prf(dk, 2), and sig_{B}←sign_{b}(g^{b}∥gd∥v, group-name_{A}). And at message 750, device 710 may send the message including sig_{B} to device 720.

Proceeding now at sub-flow 752, second computing device 720 may generate the value v according to prf(dk, 2). Still further in sub-flow 752, second device 720 may verify sig_{A} over g^{b}∥g^{d}∥v using the verification key for group-name_{B}, and generate a hash of the current title (referred to as “old-title”). Still further, second device 720 may also calculate: sk←prf(ak, 3), sid←hash(g^{b}∥g^{d}∥group-name_{B}∥group-name_{D}); h←hash(old-title_{D}); sig_{D}←sign_{D}(g^{d}∥g^{b}∥v∥h, group-name_{D}); and then delete dk, ak. And second computing device 720 may send a message 754 including h∥sig_{D}.

Responsive to receipt of this message, first device 710 may send the hash of the old-title to the block chain server, e.g., via a trusted channel, to confirm ownership and contribution of the hash to the block chain for the smart package. At this point, if not previously generated, first device 710 also may generate a new-title_{D} as title_{D}∥new-owner-record. First device 710 may also verify h=hash(title_{D}); verify sig_{D} over g^{d}∥g^{b}∥v∥h using the verification key for group-name_{D}. After verification, first device 710 may calculate sk←prf(ak, 3), sid←hash(g^{b}∥g^{d}∥group-name_{B}∥group-name_{D}); and delete dk, ak. First device 710 may also generate a signature sig←sig(sk_{B}, v∥vk_{B}∥new-title_{D}); and a←[vk_{B}∥{new-titleD}]ₛₖ; and the delete v and sk. Finally, first device 710 may send a message 758 including α∥sig to second device 720.

Responsive to receipt of this message which includes new title information, second computing device 720 may perform sub-flow 760 to update the ownership record to indicate title is now vested in buyer B. Specifically, second device 720 may use sk to extract vk_{B} and new-title_{D} from α; use vk_{B} to verify sig over v∥vk_{B}∥new-title_{D}; parse new-title_{D} as title_{D}∥new-owner-record; verify hash(title_{D})=hash(old-title_{D}); verify hash(old-title_{D})=new-owner-record.hash; verify vk_{B}=new-owner-record.buyer-public-key; use root_{D} to verify new-owner-record.seller-endorsement; delete v and sk; root_{D}←vk_{B}; and old-title_{D}←new-title_{D}. As such, second device 720 updates the title data structure to a new title having the additional and updated ownership information and transfer information. In addition, second device 720 replaces the old root device key with a new root device key. Understand that the above protocol is for a 6-message Sigma protocol: in other embodiments a Sigma variation using, e.g., 3 messages may be implemented.

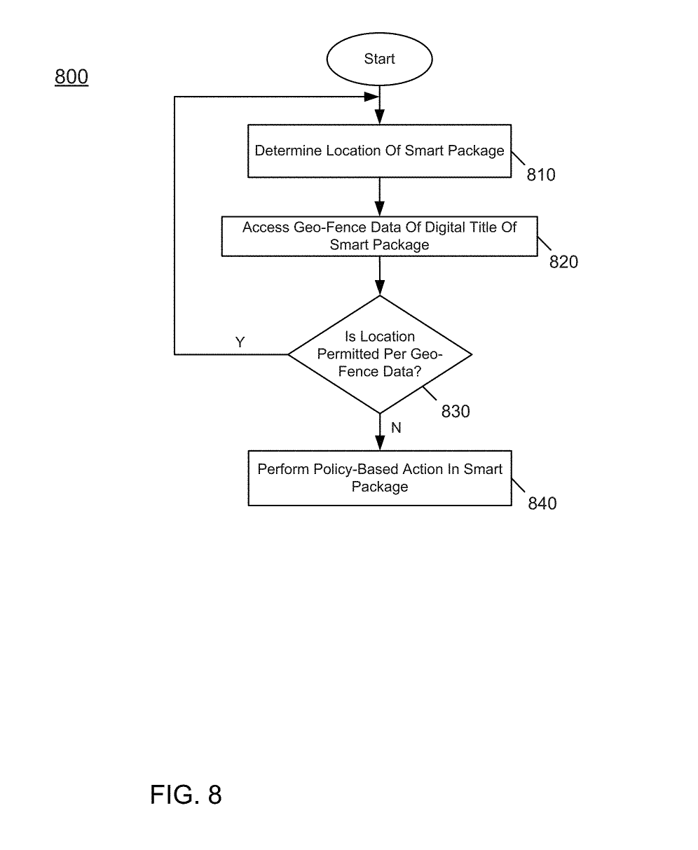

Referring now to FIG. 8, shown is a flow diagram of a geo-fencing method in accordance with an embodiment of the present invention. As illustrated in FIG. 8, method 800 may be performed by a smart package, to ensure that, in implementations in which geo-fence data is provided, the package validly remains within an area circumscribed by the geo-fence data. As such, method 800 may be performed during transit from source to destination for a given package delivery cycle.

As seen, method 800 begins by determining a location of the smart package (block 810). As an example, a smart package may include a global positioning satellite (GPS) sensor to maintain track of its location. In other embodiments, a beacon or other type of sensor may be provided within the smart package to enable location determination.

Still with reference to FIG. 8, next geo-fence data of a digital title may be accessed (block 820). More specifically as described above, in some embodiments a digital title may include geographic constraint information in the form of geo-fence data. Responsive to access of this information, which may occur during active TEE operation, it can be determined at diamond 830 whether the location is permitted per the geo-fence data. That is, based on the GPS or other location information in the geo-fence data it can be determined whether the smart package is within an approved location or area. If so, no further actions are taken and method 800 may proceed, e.g., according to a given schedule (e.g., once per hour or according to some other regular schedule).

Instead if it is determined that the location is not as permitted, control passes to block 840. At block 840 a policy-based action may be performed in the smart package. This policy-based action may be a given security protection action. As examples, this policy-based action may be logging of the location violation, such that this information may be indicated upon a next attempted ownership transfer (which may cause the ownership transfer to fail). In other cases, the policy-based action may be a location violation report that is sent out-of-band, e.g., via a given wireless communication protocol to a given entity, such as the entity that is the nominative owner of the smart package, e.g., as determined with reference to the digital title. Of course other policy-based actions such as enforcement based at least in part on physical (sensed) conditions at the time of title transfer, including time of day, temperature, pressure, motion or light may occur.

Additional policies may describe roles or privileges of the smart package/drone. For example, a drone may be authorized to deliver only packages stereotyped according to some classification or security level model such as Bell-LaPadula, Clark-Wilson or Biba models. These models tag subjects (drones) and objects (packages) with labels that implement a form of type enforcement, ensuring an impedance match exists between package and package delivery host. In this way, a high security risk package is only delivered by drones that have been deemed to be appropriate. For example, such drones may have appropriate resistance to surface-to-drone or air-to-drone attack scenarios, in some embodiments. Understand while shown at this high level in the embodiment of FIG. 8, many variations and alternatives are possible.

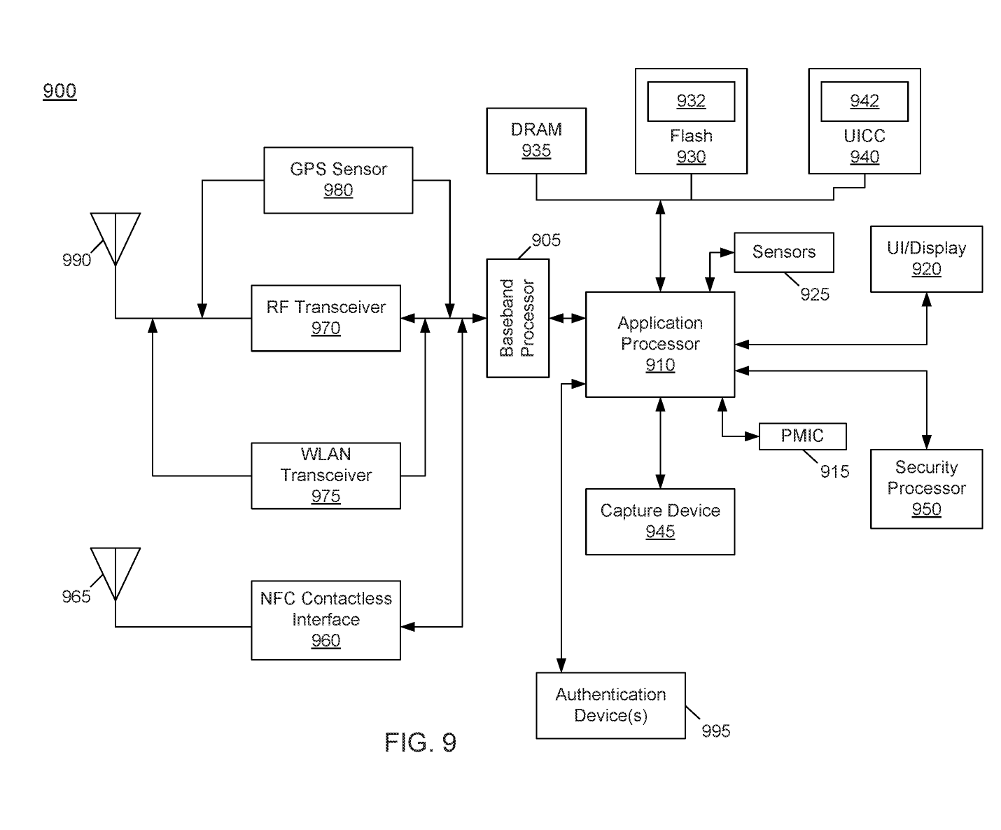

Referring now to FIG. 9, shown is a block diagram of an example system with which embodiments can be used. As seen, system 900 may be a smartphone or other wireless communicator or any other IoT device, including a delivery drone. A baseband processor 905 is configured to perform various signal processing with regard to communication signals to be transmitted from or received by the system. In turn, baseband processor 905 is coupled to an application processor 910, which may be a main CPU of the system to execute an OS and other system software, in addition to user applications such as many well-known social media and multimedia apps. Application processor 910 may further be configured to perform a variety of other computing operations for the device.

In turn, application processor 910 can couple to a user interface/display 920, e.g., a touch screen display. In addition, application processor 910 may couple to a memory system including a non-volatile memory, namely a flash memory 930 and a system memory, namely a DRAM 935. In some embodiments, flash memory 930 may include a secure portion 932 in which secrets and other sensitive information may be stored. As further seen, application processor 910 also couples to a capture device 945 such as one or more image capture devices that can record video and/or still images.

Still referring to FIG. 9, a universal integrated circuit card (UICC) 940 comprises a subscriber identity module, which in some embodiments includes a secure storage 942 to store secure user information. System 900 may further include a security processor 950 that may implement a TEE as described earlier, and which may couple to application processor 910. Furthermore, application processor 910 may implement a secure mode of operation, such as Intel® Software Guard Extensions (SGX) to a given instruction set architecture, and circuitry for hosting of a TEE, as described earlier, and which may be used to perform at least portions of an ownership transfer protocol as described herein. A plurality of sensors 925, including one or more multi-axis accelerometers may couple to application processor 910 to enable input of a variety of sensed information such as motion and other environmental information, e.g., for use in geo-fence-based policy enforcement. In addition, one or more authentication devices 995 may be used to receive, e.g., user biometric input for use in authentication operations.

As further illustrated, a near field communication (NFC) contactless interface 960 is provided that communicates in a NFC near field via an NFC antenna 965. While separate antennae are shown in FIG. 9, understand that in some implementations one antenna or a different set of antennae may be provided to enable various wireless functionality.

A power management integrated circuit (PMIC) 915 couples to application processor 910 to perform platform level power management. To this end, PMIC 915 may issue power management requests to application processor 910 to enter certain low power states as desired. Furthermore, based on platform constraints, PMIC 915 may also control the power level of other components of system 900.

To enable communications to be transmitted and received such as in one or more IoT networks, various circuitry may be coupled between baseband processor 905 and an antenna 990. Specifically, a radio frequency (RF) transceiver 970 and a wireless local area network (WLAN) transceiver 975 may be present. In general, RF transceiver 970 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 980 may be present, with location information being provided to security processor 950 for use as described herein when context information is to be used in connection with an ownership transfer process. Other wireless communications such as receipt or transmission of radio signals, e.g., AM/FM and other signals may also be provided. In addition, via WLAN transceiver 975, local wireless communications, such as according to a Bluetooth™ or IEEE 802.11 standard can also be realized.

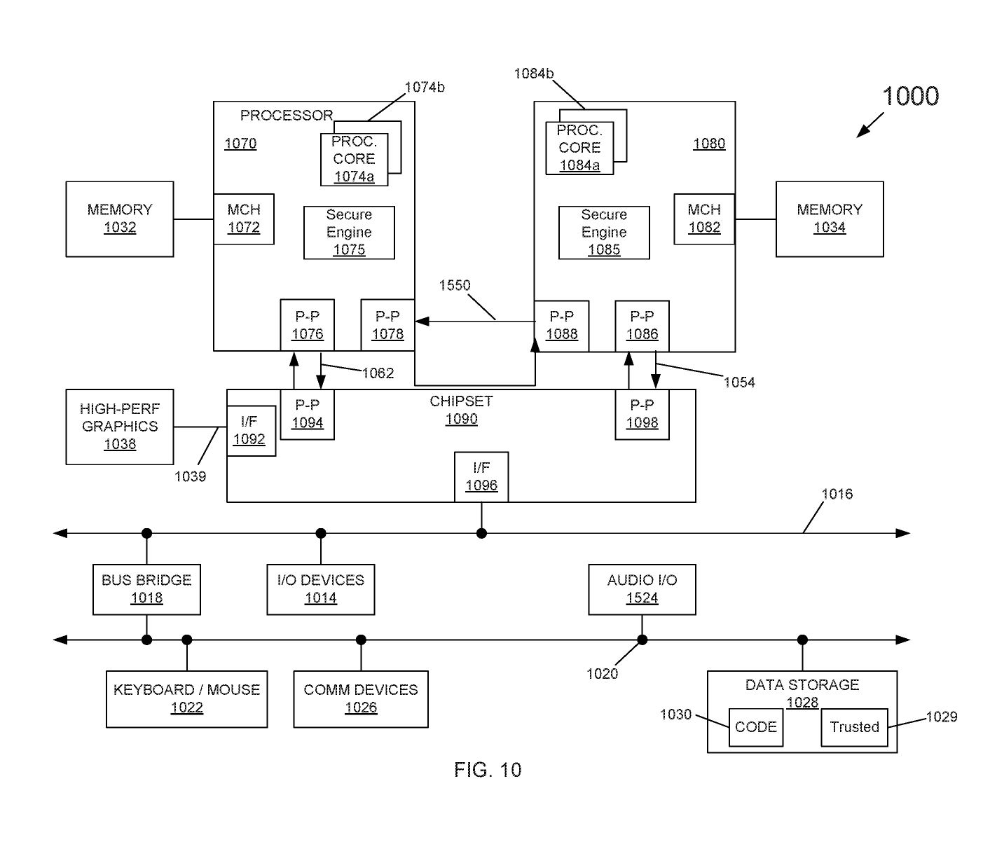

Referring now to FIG. 10, shown is a block diagram of a system in accordance with another embodiment of the present invention. As shown in FIG. 10, multiprocessor system 1000 is a point-to-point interconnect system such as a server system, and which may be used as a block chain server as described herein, and includes a first processor 1070 and a second processor 1080 coupled via a point-to-point interconnect 1050. As shown in FIG. 10, each of processors 1070 and 1080 may be multicore processors such as SoCs, including first and second processor cores (i.e., processor cores 1074a and 1074b and processor cores 1084a and 1084b), although potentially many more cores may be present in the processors. In addition, processors 1070 and 1080 each may include a secure engine 1075 and 1085 to perform security operations such as block chain verifications and maintenance for a variety of different devices including smart packages, among others.

Still referring to FIG. 10, first processor 1070 further includes a memory controller hub (MCH) 1072 and point-to-point (P-P) interfaces 1076 and 1078. Similarly, second processor 1080 includes a MCH 1082 and P-P interfaces 1086 and 1088. As shown in FIG. 10, MCH's 1072 and 1082 couple the processors to respective memories, namely a memory 1032 and a memory 1034, which may be portions of main memory (e.g., a DRAM) locally attached to the respective processors. First processor 1070 and second processor 1080 may be coupled to a chipset 1090 via P-P interconnects 1052 and 1054, respectively. As shown in FIG. 10, chipset 1090 includes P-P interfaces 1094 and 1098.

Furthermore, chipset 1090 includes an interface 1092 to couple chipset 1090 with a high performance graphics engine 1038, by a P-P interconnect 1039. In turn, chipset 1090 may be coupled to a first bus 1016 via an interface 1096. As shown in FIG. 10, various input/output (I/O) devices 1014 may be coupled to first bus 1016, along with a bus bridge 1018 which couples first bus 1016 to a second bus 1020. Various devices may be coupled to second bus 1020 including, for example, a keyboard/mouse 1022, communication devices 1026 and a data storage unit 1028 such as a non-volatile storage or other mass storage device. As seen, data storage unit 1028 may include code 1030, in one embodiment. As further seen, data storage unit 1028 also includes a trusted storage 1029 to store sensitive information to be protected. Further, an audio I/O 1024 may be coupled to second bus 1020.

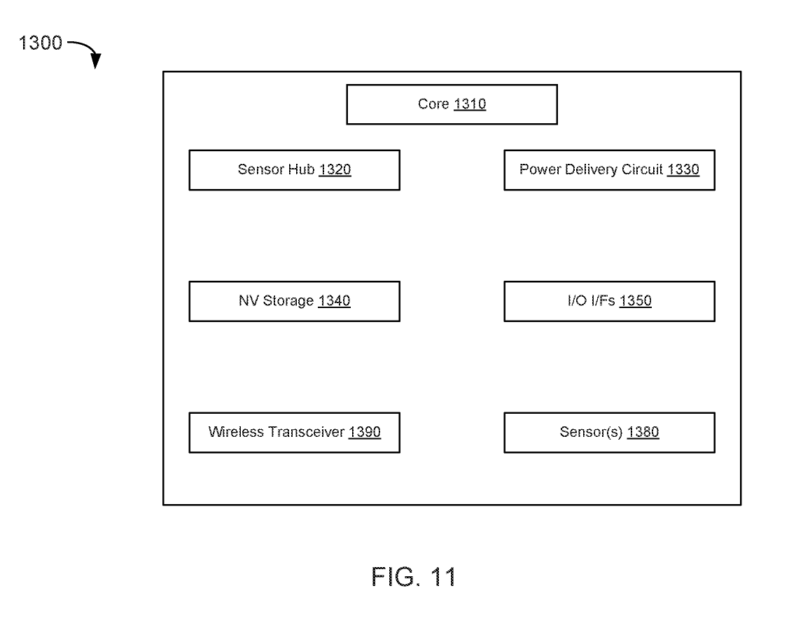

Embodiments may be used in environments where IoT devices may include wearable devices or other small form factor IoT devices, which may be adapted within a smart package as described herein. Referring now to FIG. 11, shown is a block diagram of a wearable module 1300 in accordance with another embodiment. In one particular implementation, module 1300 may be an Intel® Curie™ module that includes multiple components adapted within a single small module that can be implemented as all or part of a wearable (or insertable) device. As seen, module 1300 includes a core 1310 (of course in other embodiments more than one core may be present). Such core may be a relatively low complexity in-order core, such as based on an Intel Architecture® Quark™ design. In some embodiments, core 1310 may implement a TEE as described herein. Core 1310 couples to various components including a sensor hub 1320, which may be configured to interact with a plurality of sensors 1380, such as one or more biometric, motion environmental or other sensors. A power delivery circuit 1330 is present, along with a non-volatile storage 1340. In an embodiment, this circuit may include a rechargeable battery and a recharging circuit, which may in one embodiment receive charging power wirelessly. One or more input/output (IO) interfaces 1350, such as one or more interfaces compatible with one or more of USB/SPI/I²C/GPIO protocols, may be present. In addition, a wireless transceiver 1390, which may be a Bluetooth™ low energy or other short-range wireless transceiver is present to enable wireless communications as described herein. Understand that in different implementations a wearable module can take many other forms.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

In Example 1, an apparatus comprises: a hardware processor; a storage to store a digital title comprising a first ownership record having a public key of a current owner of the apparatus, the public key to be endorsed by a prior owner of the apparatus; and a wireless circuit to transmit and receive messages. The hardware processor is to generate a hash of a prior ownership record, and the wireless circuit is to cause the hash to be provided to a remote server that is to maintain a block chain regarding ownership of the apparatus.

In Example 2, the apparatus comprises a smart package to carry at least one article to be delivered from a source location to a destination location via one or more intermediary entities.

In Example 3, the smart package comprises a smart delivery container comprising a trusted execution environment including the storage, the storage comprising a secure storage.

In Example 4, the apparatus is to send an out-of-band alert to at least one remote entity responsive to a routing of the smart package beyond a geo-fence identified in a geographic field of the digital title.

In Example 5, the storage of one or more of the above Examples further comprises an embedded key associated with a manufacturer of the hardware processor.

In Example 6, the hardware processor of Example 5 is to sign the hash with the embedded key before provision to the remote server.

In Example 7, the hardware processor is to: perform an authentication protocol with a delivery resource and responsive to authentication of the delivery resource, receive a second ownership record having a public key of the delivery resource; and verify the second ownership record and responsive to verification of the second ownership record, store the second ownership record in the storage.

In Example 8, the verification of Example 7 comprises a verification of a geographic location at which the delivery resource is to take ownership of the apparatus.

In Example 9, the hardware processor of Example 7 is to generate a second hash of the first ownership record, and the wireless circuit is to cause the second hash to be provided to the remote server.

In Example 10, the apparatus of Example 9 is to replace the first ownership record with the second ownership record responsive to acknowledgment of receipt of the second hash by the remote server.

In Example 11, the delivery resource comprises a network independent delivery drone to deliver the smart package from a first intermediate location between the source location and the destination location.

In Example 12, a method comprises: receiving, in a system via a wireless link, credential information from a secure storage of a smart package, the smart package to securely carry an article from a source to a destination, the credential information including at least a portion of an ownership record of the smart package, the ownership record including a public key of a first owner of the smart package and first geo-fence data to indicate acceptable location presence of the smart package; verifying the credential information via communication of at least some of the credential information to a server that maintains a block chain for the smart package; and providing a new ownership record to the smart package, to enable a transfer of ownership to the system, the new ownership record comprising a public key of the system and second geo-fence data, where the new ownership record is to be stored in the secure storage of the smart package.

In Example 13, the system comprises one of a RFID wireless computing system and a delivery drone.

In Example 14, the verification of the credential information includes a confirmation that the smart package has been maintained within an acceptable location per the first geo-fence data.

In Example 15, at least some of the credential information comprises a hash of the ownership record, and the method further comprises communicating the hash to the server.

In Example 16, the method of one or more of the above Examples further comprises: receiving acknowledgement from the server of receipt of the hash by the server; and providing the acknowledgement to the smart package, to enable the smart package to store the new ownership record in the secure storage.

In Example 17, the new ownership record is to replace the ownership record in the secure storage, responsive to the acknowledgement.

In Example 18, a method comprises: communicating, via a first wireless device, with a smart package including a trusted execution environment and a secure storage, to obtain credential information of the smart package, the credential information including ownership information of the smart package, the smart package to securely carry an article from a source to a destination; communicating from the first wireless device to a verification server, to verify the credential information, the verification server maintaining a block chain for ownership transfers of the smart package; and providing, via the first wireless device, a second ownership record to the smart package to transfer ownership of the smart package to an entity associated with the first wireless device, where responsive to verification of the credential information the smart package is to store the second ownership record in the secure storage.

In Example 19, the method further comprises providing routing information from the first wireless device to the smart package, where the smart package is to send an out-of-band alert to at least one remote entity responsive to a routing of the smart package beyond an area indicated in the routing information.

In Example 20, at least some of the credential information comprises a hash of the ownership information, and the method further comprises communicating the hash to the verification server to enable the verification server to update the block chain.

In another Example, a computer readable medium including instructions is to perform the method of any of the above Examples.

In another Example, a computer readable medium including data is to be used by at least one machine to fabricate at least one integrated circuit to perform the method of any one of the above Examples.

In another Example, an apparatus comprises means for performing the method of any one of the above Examples.

In Example 21, a system comprises: means for communicating with a smart package including a trusted execution environment and a secure storage, to obtain credential information of the smart package, the credential information including ownership information of the smart package, the smart package to securely carry an article from a source to a destination; means for communicating to a verification server, to verify the credential information, the verification server maintaining a block chain for ownership transfers of the smart package; and means for providing a second ownership record to the smart package to transfer ownership of the smart package to an entity associated with the first wireless device, where responsive to verification of the credential information the smart package is to store the second ownership record in the secure storage.

In Example 22, the system further comprises means for providing routing information to the smart package, where the smart package is to send an out-of-band alert to at least one remote entity responsive to a routing of the smart package beyond an area indicated in the routing information.

In Example 23, at least some of the credential information comprises a hash of the ownership information, and the system further comprises means for communicating the hash to the verification server to enable the verification server to update the block chain.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a hardware processor;
a storage to store a digital title comprising a first ownership record having a public key of a current owner of the apparatus, the public key to be endorsed by a prior owner of the apparatus; and
a wireless circuit to transmit and receive messages, wherein the hardware processor is to generate a hash of a prior ownership record, and the wireless circuit is to cause the hash to be provided to a remote server that is to maintain a block chain regarding ownership of the apparatus.

2. The apparatus of claim 1, wherein the apparatus comprises a smart package to carry at least one article to be delivered from a source location to a destination location via one or more intermediary entities.

3. The apparatus of claim 2, wherein the smart package comprises a smart delivery container comprising a trusted execution environment including the storage, the storage comprising a secure storage.

4. The apparatus of claim 2, wherein apparatus is to send an out-of-band alert to at least one remote entity responsive to a routing of the smart package beyond a geo-fence identified in a geographic field of the digital title.

5. The apparatus of claim 1, wherein the storage further comprises an embedded key associated with a manufacturer of the hardware processor.

6. The apparatus of claim 5, wherein the hardware processor is to sign the hash with the embedded key before provision to the remote server.

7. The apparatus of claim 1, wherein the hardware processor is to:
perform an authentication protocol with a delivery resource and responsive to authentication of the delivery resource, receive a second ownership record having a public key of the delivery resource; and
verify the second ownership record and responsive to verification of the second ownership record, store the second ownership record in the storage.

8. The apparatus of claim 7, wherein the verification comprises a verification of a geographic location at which the delivery resource is to take ownership of the apparatus.

9. The apparatus of claim 7, wherein the hardware processor is to generate a second hash of the first ownership record, and the wireless circuit is to cause the second hash to be provided to the remote server.

10. The apparatus of claim 9, wherein the apparatus is to replace the first ownership record with the second ownership record responsive to acknowledgment of receipt of the second hash by the remote server.

11. The apparatus of claim 7, wherein the delivery resource comprises a network independent delivery drone to deliver the smart package from a first intermediate location between the source location and the destination location.

12. At least one computer readable storage medium comprising instructions that when executed enable a system to:
receive, in the system via a wireless link, credential information from a secure storage of a smart package, the smart package to securely carry an article from a source to a destination, the credential information including at least a portion of an ownership record of the smart package, the ownership record including a public key of a first owner of the smart package and first geo-fence data to indicate acceptable location presence of the smart package;
verify the credential information via communication of at least some of the credential information to a server that maintains a block chain for the smart package; and
provide a new ownership record to the smart package, to enable a transfer of ownership to the system, the new ownership record comprising a public key of the system and second geo-fence data, wherein the new ownership record is to be stored in the secure storage of the smart package.

13. The at least one computer readable storage medium of claim 12, wherein the system comprises one of a radio frequency identification (RFID) wireless computing system and a delivery drone.

14. The at least one computer readable storage medium of claim 12, wherein the verification of the credential information includes a confirmation that the smart package has been maintained within an acceptable location per the first geo-fence data.

15. The at least one computer readable storage medium of claim 12, wherein at least some of the credential information comprises a hash of the ownership record, and further comprising instructions that when executed enable the system to communicate the hash to the server.

16. The at least one computer readable storage medium of claim 15, further comprising instructions that when executed enable the system to:
receive acknowledgement from the server of receipt of the hash by the server; and
provide the acknowledgement to the smart package, to enable the smart package to store the new ownership record in the secure storage.

17. The at least one computer readable storage medium of claim 16, wherein the new ownership record is to replace the ownership record in the secure storage, responsive to the acknowledgement.

18. A method comprising:
communicating, via a first wireless device, with a smart package including a trusted execution environment and a secure storage, to obtain credential information of the smart package, the credential information including ownership information of the smart package, the smart package to securely carry an article from a source to a destination;
communicating from the first wireless device to a verification server, to verify the credential information, the verification server maintaining a block chain for ownership transfers of the smart package; and
providing, via the first wireless device, a second ownership record to the smart package to transfer ownership of the smart package to an entity associated with the first wireless device, wherein responsive to verification of the credential information the smart package is to store the second ownership record in the secure storage.

19. The method of claim 18, further comprising providing routing information from the first wireless device to the smart package, wherein the smart package is to send an out-of-band alert to at least one remote entity responsive to a routing of the smart package beyond an area indicated in the routing information.

20. The method of claim 18, wherein at least some of the credential information comprises a hash of the ownership information, and communicating the hash to the verification server to enable the verification server to update the block chain.
